(19) United States
(12) Patent Application Publication
(10) Pub. No.: US 2025/0200626 A1
(43) Pub. Date: Jun. 19, 2025

(54) Visual Search Query Intent Extraction and Search Refinement

(71) Applicant: eBay Inc., San Jose, CA (US)

(72) Inventors: Senthilkumar Gopal, Fremont, CA (US); Shubhangi Tandon, Dublin, CA (US)

(73) Assignee: eBay Inc., San Jose, CA (US)

(21) Appl. No.: 18/545,257

(22) Filed: Dec. 19, 2023

(51) Int. Cl. G06Q 30/0601; G06F 3/0482; G06Q 30/0201

(52) U.S. Cl. CPC G06Q 30/0627; G06F 3/0482; G06Q 30/0201; G06Q 30/0643

(57) ABSTRACT

Visual search query intent extraction and search refinement is described. In one or more implementations, a visual search query system receives a search query for items listed on an online marketplace, the search query including an image. Using one or more machine learning models, the visual search query system analyzes the image to determine characteristics of an object in the image. Based on the characteristics of the object in the image, the visual search query system automatically generates one or more search terms and searches the online marketplace to locate items matching the one or more search terms. The visual search query system then displays visual indications of the located items matching the one or more search terms in a user interface of the online marketplace.

### BACKGROUND

Visual search on e-commerce platforms faces several challenges. Inconsistent image quality and variations in item images can hinder accurate identification by visual search algorithms. Recognizing objects within images, especially when items come in various sizes, colors, and styles, requires advanced object recognition and differentiation capabilities. Bridging the semantic gap between user queries and item tagging and ensuring user adoption can be complex. Additionally, handling a large volume of images efficiently while managing the associated costs and resources is a significant challenge. Finally, the competitive landscape and rising user expectations for visual search technology compel e-commerce platforms to continually improve and innovate in this area to stay competitive.

### SUMMARY

Visual search query intent extraction and search refinement is described. In an implementation, a visual search query system is configured to receive a search query for items listed on an online marketplace, the search query including an image. Using one or more machine learning models, the visual search query system analyzes the image to determine characteristics of an object in the image. For example, the characteristics of the object designate a price, a brand, or a designation of luxury for the object in the image. In one or more examples, the one or more machine learning models are trained using training data that includes images of items listed on the online marketplace, the images of the items associated with characteristics of the items, the characteristics of the items extracted from listing data. The visual search query system automatically generates one or more search terms based on the characteristics of the object in the image and searches the online marketplace to locate items matching the one or more search terms. The visual search query system then displays visual indications of the located items matching the one or more search terms in the online marketplace.

In one or more examples, the visual search query system is configured to receive a user input to remove at least one of the one or more search terms. Responsive to the user input to remove the at least one of the one or more search terms, the visual search query system filters the visual indications of the located items.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures.

FIG. 1 is an illustration of a digital medium environment in an example implementation that is operable to employ visual search query intent extraction and search refinement techniques described herein.

FIG. 2 depicts an example of a user interface for visual search query intent extraction and search refinement.

FIG. 3 depicts an example of a user interface for visual search query intent extraction and search refinement including an image capture prompt.

FIG. 4 depicts an example of a user interface for visual search query intent extraction and search refinement including a search refinement prompt.

FIG. 5 depicts an example of a user interface for visual search query intent extraction and search refinement including displaying search terms.

FIG. 6 depicts an example of a user interface for visual search query intent extraction and search refinement including visual indications of located items matching the search terms.

FIG. 7 depicts an example of training one or more machine learning models for visual search query intent extraction and search refinement.

FIG. 8 is a flow diagram depicting an algorithm as a step-by-step procedure in an example of implementing visual search query intent extraction and search refinement.

FIG. 9 is a flow diagram depicting an algorithm as a step-by-step procedure in an additional example of implementing visual search query intent extraction and search refinement.

FIG. 10 is a flow diagram depicting an algorithm as a step-by-step procedure in an additional example of implementing visual search query intent extraction and search refinement.

FIG. 11 illustrates an example system including various components of an example device that can be implemented as any type of computing device as described and/or utilized with reference to FIGS. 1-10 to implement embodiments of the techniques described herein.

### DETAILED DESCRIPTION

Overview

Online shopping allows users to browse millions of items for sale. An input is received by a search query system depicting an intended item as part of a query that also includes search words describing the intended item. Item listings with descriptions matching the search words are then returned as part of a search result by the search query system. However, with so many options, finding the right search words to locate the item the user intends is challenging. Many items also have unique qualities that are difficult to describe using words, or are incorrectly described on an item listing, preventing the user from locating the intended item even with correct search words.

Conventional techniques have been developed to search for similar images to an input image. This allows the user to bypass attempts to describe the intended item using search words, because an image is uploaded instead depicting an item that the user intends to locate online. However, these conventional techniques are limited to searching for images that are visually similar to the input image. Limitation to visual similarity is unhelpful in scenarios in which an image of the intended item is unavailable or unknown. For example, consider an attempt to shop for a new watch. The user currently has an inexpensive silver watch but intends to upgrade to a luxury gold watch.

Because the user does not know how to accurately describe the intended watch, the user captures an image of the inexpensive silver watch to input into a conventional image search application. However, the user is disappointed to receive search results that are visually similar to the inexpensive silver watch, and no search results for luxury gold watches.

Accordingly, techniques and systems are described for visual search query intent extraction and search refinement that address these limitations. A visual search query system begins in this example by receiving a search query including an image that is captured using a camera or uploaded to the visual search query system via a user interface associated with the visual search query system. The image depicts an object with at least one characteristic this is to be subject for a search for on an online marketplace. In this example, the image depicts the inexpensive silver watch. Although the watch is a different color and level of luxury than the watch the user intends to search for on the online marketplace, the inexpensive silver watch has some characteristics that the user intends to search for, including its identity as a wristwatch and its brand.

The search query system uses a machine learning model to analyze the image to determine characteristics of the object in the image. The machine learning model is trained on noisy versions of item listings and corresponding item labels from the online marketplace. This training allows the machine learning model to identify characteristics of the object and generate text describing the characteristics. For example, the machine learning model identifies characteristics of the watch including a color of silver, a brand of WatchMaker, and an indication that the watch is not luxury.

The search query system then generates search terms based on the characteristics of the object. To extract the user's intent from the visual search query, the search query term provides the search terms to the viewer with an option to edit or remove the search terms. For example, search terms including “wristwatch,” “color silver,” “brand WatchMaker,” and “not luxury” are provided to the user in a user interface of the online marketplace. In some implementations, the search terms are displayed next to visual indications of initial search results showing listings from the online marketplace matching the search terms. Because the user intends to find a luxury WatchMaker brand watch in gold, the user changes the color from “silver” to “gold” and changes the indication of luxury from “not luxury” to “luxury.”

The search query system then conducts a search of the online marketplace to locate listings for items matching the search terms. The search yields listings for items with descriptions or visual characteristics that correspond to the search terms, as identified by the machine learning model. The search query system extracts visual indications of the items matching the search terms, including images of the items on the online marketplace, and displays the visual indications in the user interface. For example, multiple results including images of gold WatchMaker brand luxury watches listed for sale on the online marketplace populate the user interface. The search query results accurately portray the user's intent for the visual search query, and the user is able to purchase one of the watches from the online marketplace.

Extracting visual search query intent and refining the search in this manner overcomes the disadvantages of conventional image search techniques that are limited to returning visually similar images that do not embody the user's intentions for the visual search query. Analyzing the image to determine characteristics of the object in the image using the machine learning model and automatically generating search terms based on the characteristics allows for flexibility in refining a search query by editing or removing search terms to generate a search query that aligns with the user's intentions. Displaying visual indications of located items that match the search terms also provides a convenient medium for browsing items listed for sale on the online marketplace and for filtering the located items based on further refinement of the search terms. This leads to increased conversion rates and user satisfaction because the user is able to locate an intended item.

In some aspects, the techniques described herein relate to a computer-implemented method including: receiving a search query for items listed on an online marketplace, the search query including an image, analyzing, using one or more machine learning models, the image to determine characteristics of an object in the image, automatically generating one or more search terms based on the characteristics of the object in the image, searching the online marketplace to locate items matching the one or more search terms, and displaying visual indications of located items matching the one or more search terms in the online marketplace.

In some aspects, the techniques described herein relate to a computer-implemented method, further including displaying the one or more search terms proximate to the visual indications of the located items in a user interface.

In some aspects, the techniques described herein relate to a computer-implemented method, further including: receiving a user input to remove at least one of the one or more search terms, and responsive to the user input to remove the at least one of the one or more search terms, filtering the visual indications of the located items.

In some aspects, the techniques described herein relate to a computer-implemented method, wherein the characteristics are based on intended characteristics of an item to purchase.

In some aspects, the techniques described herein relate to a computer-implemented method, wherein the one or more machine learning models are trained using training data that includes images of items listed on the online marketplace, the images of the items associated with characteristics of the items, the characteristics of the items extracted from listing data.

In some aspects, the techniques described herein relate to a computer-implemented method, further including adding noise to the images of the items in the training data.

In some aspects, the techniques described herein relate to a computer-implemented method, wherein the one or more machine learning models are trained using training data that includes images uploaded to the online marketplace as part of a search query.

In some aspects, the techniques described herein relate to a computer-implemented method, wherein the one or more machine learning models are trained using user purchase history.

In some aspects, the techniques described herein relate to a computer-implemented method, wherein the characteristics of the object designate a price, a brand, or a designation of luxury for the object in the image.

In some aspects, the techniques described herein relate to a system including: a memory component, and a processing device coupled to the memory component, the processing device to perform operations including: analyzing, using one or more machine learning models, an image to determine characteristics of an object in the image, automatically generating one or more search terms based on the characteristics of the object in the image, updating the one or more search terms by removing or adding a search term based on a user input, and searching an online marketplace to locate items matching the one or more search terms.

In some aspects, the techniques described herein relate to a system, further including displaying the one or more search terms proximate to visual indications of located items matching the one or more search terms in a user interface.

In some aspects, the techniques described herein relate to a system, wherein the one or more machine learning models are trained using training data that includes images of items listed on the online marketplace, the images of the items associated with characteristics of the items, the characteristics of the items extracted from listing data.

In some aspects, the techniques described herein relate to a system, further including adding noise to the images of the items in the training data.

In some aspects, the techniques described herein relate to a system, wherein the one or more machine learning models are trained using training data that includes images uploaded to the online marketplace as part of a search query.

In some aspects, the techniques described herein relate to a system, wherein the one or more machine learning models are trained using user purchase history.

In some aspects, the techniques described herein relate to a system, wherein the characteristics are based on intended characteristics of an item to purchase.

In some aspects, the techniques described herein relate to a non-transitory computer-readable storage medium storing executable instructions, which when executed by a processing device, cause the processing device to perform operations including: receiving images of items listed on an online marketplace, the images of the items associated with one or more tags indicating characteristics of the items, the characteristics of the items extracted from listing data, generating training data based on the images of the items and the one or more tags by adding noise to the images of the items, and training at least one machine learning model to generate one or more search terms based on characteristics of an object in an input image based on the training data.

In some aspects, the techniques described herein relate to a non-transitory computer-readable storage medium, wherein the at least one machine learning model is further trained on images uploaded to the online marketplace as part of a search query.

In some aspects, the techniques described herein relate to a non-transitory computer-readable storage medium, wherein the at least one machine learning model is further trained on user purchase history.

In some aspects, the techniques described herein relate to a non-transitory computer-readable storage medium, wherein the at least one machine learning model is further trained to update the one or more search terms based on a user input.

In the following discussion, an exemplary environment is first described that may employ the techniques described herein. Examples of implementation details and procedures are then described which may be performed in the exemplary environment as well as other environments. Performance of the exemplary procedures is not limited to the exemplary environment and the exemplary environment is not limited to performance of the exemplary procedures.

### EXAMPLE OF AN ENVIRONMENT

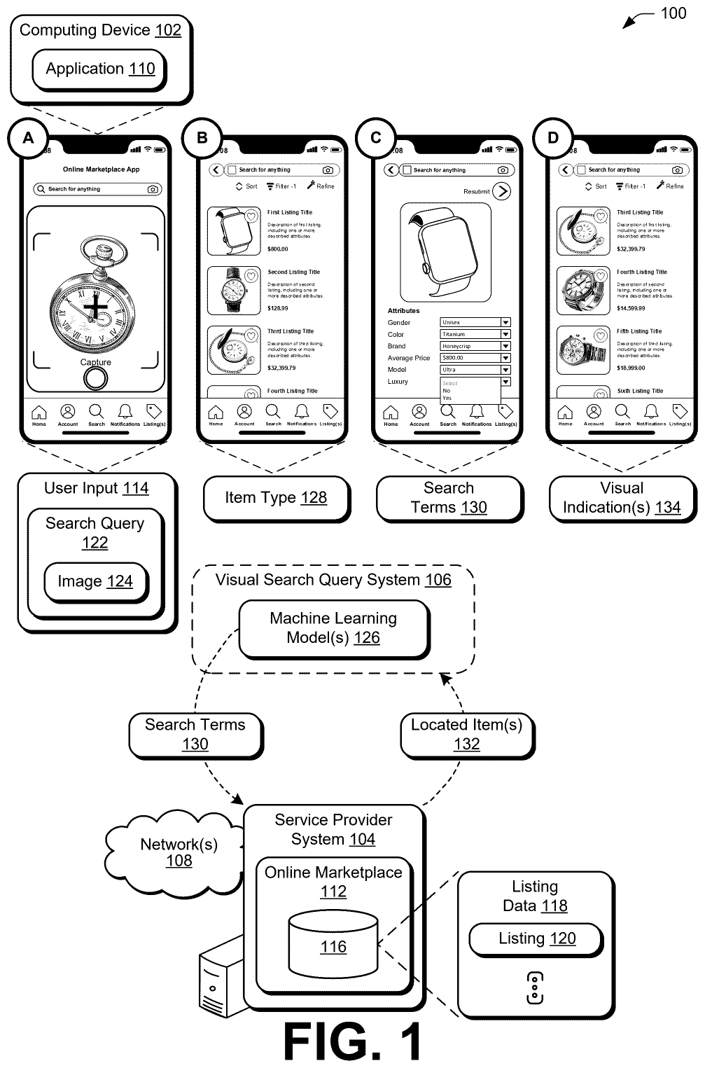

FIG. 1 is an illustration of an environment 100 in an example implementation that is operable to employ techniques described herein. The environment 100 includes a computing device 102, a service provider system 104, and a visual search query system 106. In one or more implementations, the computing device 102, the service provider system 104, and the visual search query system 106 are communicatively coupled, one to another, via network(s) 108. One example of the network(s) 108 is the Internet, although one or more of the computing device 102, the service provider system 104, and the visual search query system 106 may be communicatively coupled using one or more different connections or different networks in various implementations.

Although the visual search query system 106 is depicted in the environment 100 as being separate from the computing device 102 and the service provider system 104, in one or more implementations, an entirety or various portions of the visual search query system 106 are implemented at or by the computing device 102 and/or the service provider system 104. In at least one implementation, for example, at least a portion of the visual search query system 106 is computer-implemented by an application 110 of the computing device 102 and/or using various resources of the computing device 102, such as hardware resources, an operating system, firmware, and so forth. Alternatively or additionally, at least a portion of the visual search query system 106 is implemented by resources (e.g., server-based storage, processing, and so on) of the service provider system 104. Alternatively or additionally, at least a portion of the visual search query system 106 is implemented using a third-party service, such as a web services platform that provides one or more hardware and/or other computing resources to support provision of services by web service providers.

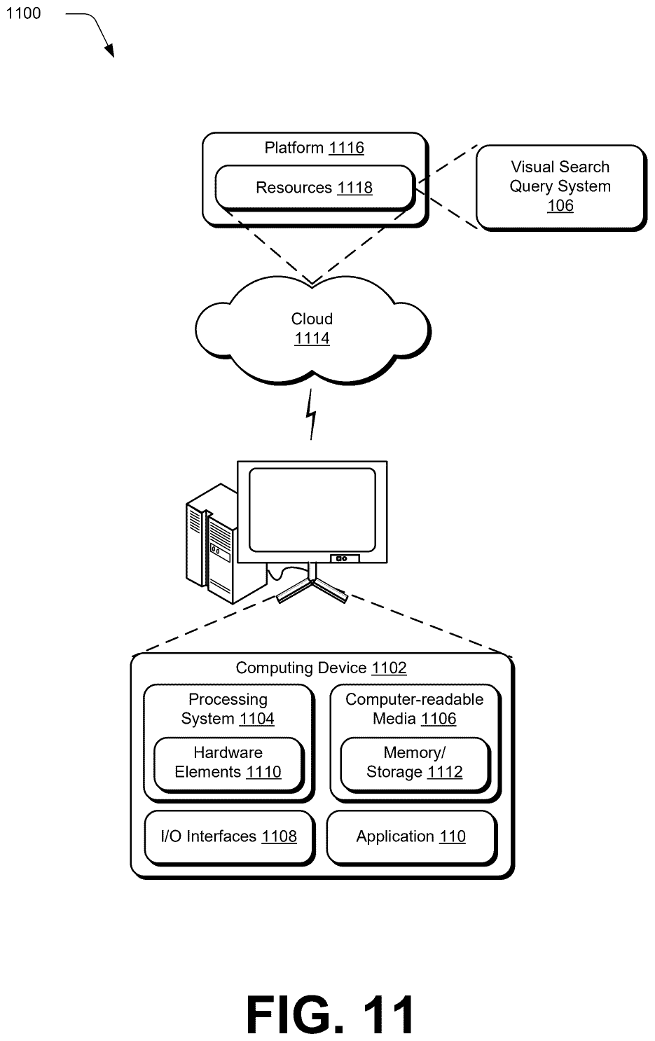

Computing devices that implement the environment 100 are configurable in a variety of ways. A computing device, for instance, is configurable as a desktop computer, a laptop computer, a mobile device (e.g., assuming a handheld configuration such as a tablet or mobile phone), an IoT device, a wearable device (e.g., a smart watch, a ring, or smart glasses), an AR/VR device (e.g., the smart glasses), a server, and so forth. Thus, a computing device ranges from full resource devices with substantial memory and processor resources to low-resource devices with limited memory and/or processing resources. Additionally, although in instances in the following discussion reference is made to a computing device in the singular, a computing device is also representative of a plurality of different devices, such as multiple servers of a server farm utilized to perform operations “over the cloud” as further described in relation to FIG. 11.

In at least one implementation, the application 110 supports communication of data across the network(s) 108 between the computing device 102 and the service provider system 104. By supporting such data communication, the application 110 provides a respective user of the computing device 102 (and users of other computing devices) access to online marketplace 112. For example, the computing device 102 receives data from the service provider system 104. Based on the received data, the application 110 causes various systems of the computing device 102 to output user interfaces of the online marketplace 112, such as by displaying user interfaces via display devices or making accessible voice-based user interfaces.

Through interaction of a user with the computing device 102, the application 110 receives a user input 114 via one or more user interfaces of the online marketplace 112. Examples of such input include, but are not limited to, receiving touch input in relation to portions of a displayed user interface, receiving one or more voice commands, receiving typed input (e.g., via a physical or virtual (“soft”) keyboard), receiving mouse or stylus input, and so forth. One example of the application 110 is a browser, which is operable to navigate to a website of the online marketplace 112, display pages of the website, and facilitate user interaction with web pages of the online marketplace 112′s website. Another example of the application 110 is a web-based computer application of the online marketplace 112, such as a mobile application or a desktop application. The application 110 may be configured in different ways, which enable users to interact with their computing devices and by extension perform actions on the online marketplace 112, without departing from the spirit or scope of the techniques described herein.

In one or more implementations, users register with the service provider system 104 to obtain respective user accounts with the online marketplace 112. Such registration may include, for instance, providing an email address and establishing a username and password combination. Subsequent to registering with the service provider system 104 computing devices (e.g., the computing device 102) facilitate signing into, or otherwise authenticating to, the user account in various ways, such as by receiving a username and matching password, receiving biometric information (e.g., at least one image captured of a face or information captured of another body part such as a thumb or finger) that suitably matches stored biometric information associated with the user account, and so forth. In at least some scenarios, however, the user account via which a user accesses the online marketplace 112 may be a guest account that does not require a user to sign in or otherwise authenticate to an already established account before interacting with the online marketplace 112.

Broadly speaking, the online marketplace 112 is configured to generate listings for items and to expose those listings (e.g., publish them) to one or more computing devices, including the computing device 102. For example, the online marketplace 112 may generate listings for items for sale and expose those listings to computing devices, such that the users of the computing devices can interact with the listings via user interfaces to initiate transactions (e.g., purchases, add to wish lists, share, and so on) in relation to the respective item or items of the listings. In accordance with the described techniques, the online marketplace 112 is configured to generate listings for one or more types of physical goods or property (e.g., clothing and/or clothing accessories, collectibles, furniture, decorative items, textiles, luxury items, electronics, real property, physical computer-readable storage having one or more video games stored thereon, and so on), services (e.g., babysitting, dog walking, house cleaning, and so on), digital items (e.g., digital images, digital music, digital videos) that can be downloaded via the network(s) 108, and blockchain backed assets (e.g., non-fungible tokens (NFTs)), to name just a few.

In the illustrated environment 100, the online marketplace 112 includes a storage device 116, which is depicted maintaining listing data 118. The listing data 118 includes listings of the online marketplace 112, one example of which is a listing 120. The listing data 118 is depicted with ellipses to indicate the existence of more listings than the listing 120. The storage device 116 may represent one or more databases and/or other types of storage capable of storing the listing data 118. Examples of the storage device 116 include, but are not limited to, mass storage and virtual storage. In one or more implementations, for example, the storage device 116 may be virtualized across a plurality of data centers and/or cloud-based storage devices. The service provider system 104 may implement the online marketplace 112 by using servers that execute stored instructions to deploy various services of the service provider system 104, such that those servers perform numerous computations which are effective to provide the functionality described above and below. It is to be appreciated that the online marketplace 112 may include more, fewer, or different components without departing from the spirit or scope described herein. In one or more implementations, the online marketplace 112 is accessible by decentralized computing devices that correspond to “clients” of the online marketplace 112, e.g., users that have accounts with the online marketplace 112.

The illustrated environment 100 depicts the application 110 of the computing device 102 at four different times, i.e., a first time ‘A,’ a second time ‘B,’ a third time ‘C,’ and a fourth time ‘D,’ depicting different steps of visual search query intent extraction and search refinement. Although steps of visual search query intent extraction and search refinement are illustrated in this order, the steps may be performed in any order and with any number of steps.

In the illustrated environment 100, the visual search query system 106 receives a search query 122 that includes an image 124. The image 124 depicts an object that shares at least one characteristic with an item a user intends to locate on the online marketplace 112. In the example depicted at step ‘A’ of the illustrated environment 100, the user captures an image 124 of a physical pocket watch using a camera feature of the application 110 on the computing device 102. The image 124 is received as a search query 122 by the visual search query system 106, indicating that the user intends to find listings for items on the online marketplace 112 with characteristics related to the object in the image 124.

The object includes multiple characteristics, which are features including, but not limited to, color, brand, price, model, luxury status, and material. However, the user does not intend to search for items matching all characteristics of the object. For example, the user captured an image of a pocket watch, but intends to search for more luxurious models than the pocket watch. To determine which characteristics of the object that the user intends to convey in the search query 122, the visual search query system 106 uses a machine learning model 126 to determine an item type 128 for the object. The machine learning model 126 is configured to include and/or have access to any of a variety of known technologies (e.g., object recognition, bounding boxes, saliency maps, etc.) to process the image 124 of the object to extract information usable to classify the object as the item type 128. In the example depicted at step ‘B’ of the example environment 100, the machine learning model 126 identifies the item type 128 as a watch. In some examples, as illustrated at step ‘B,’ the visual search query system 106 displays preliminary listings indicating available items of the item type 128 on the online marketplace 112.

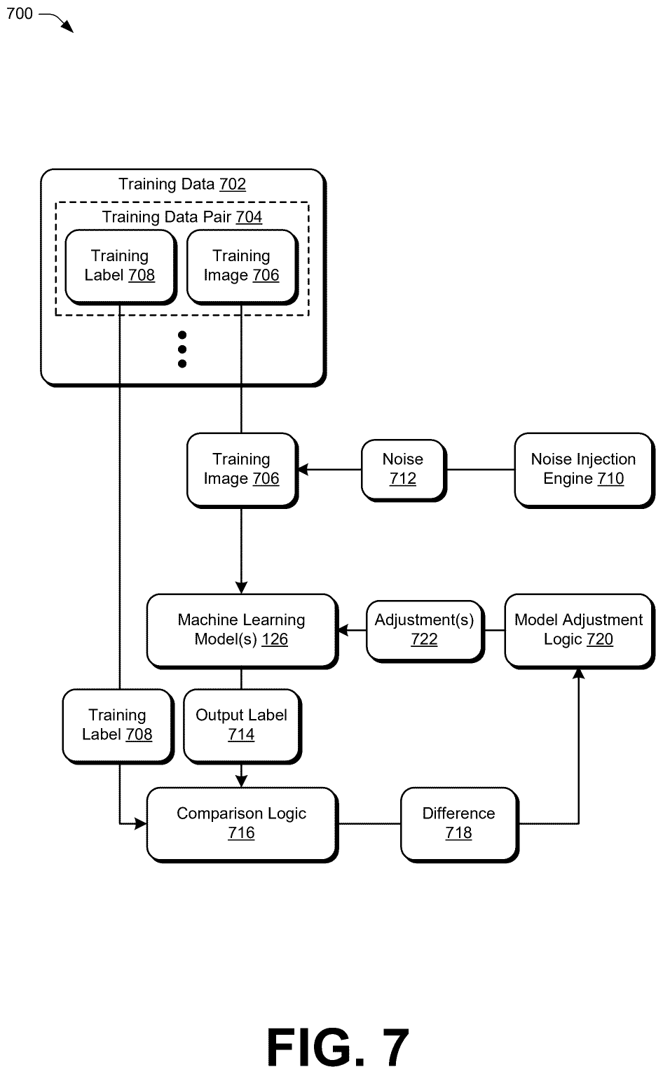

The visual search query system 106 then uses the machine learning model 126 to determine characteristics of the object based on the item type 128. In the example depicted at step ‘C’ of the illustrated environment 100, characteristics of the watch include gender, color, brand, average price, model, and indication of luxury. The characteristics are based on item characteristics extracted from listing data 118 corresponding to items of the item type 128, are predetermined based on the item type 128, or are determined by the machine learning model 126. Training of the machine learning model 126 to determine characteristics of the object is described in detail with respect to FIG. 7.

The visual search query system 106 then generates search terms 130 based on the characteristics of the object in the image 124. The machine learning model 126 generates and outputs the search terms 130 (e.g., text tags, text strings, or other suitable format of information) to locate items in listings on the online marketplace 112 that include characteristics of the object. In some examples, the visual search query system 106 generates a prompt in the user interface of the application 110 that allows the user to change, remove, or add one or more of the search terms 130. As illustrated in step ‘C,’ the search terms 130 include a gender of “Unisex,” a color of “Titanium,” a brand of “Honeycrisp,” an average price of “$800.00,” a model of “Ultra,” and a luxury designation of “No.” In this example, the user updates the search term corresponding to luxury designation from “No” to “Yes” because the user intends to view item listings corresponding to luxury watches. In some examples, changing a luxury designation automatically adjusts the average price search term. The visual search query system 106 receives the user input to change the search terms 130 and updates the search terms 130 based on the user input, allowing the visual search query system 106 to extract the user's visual search query intent to refine the item search.

The visual search query system 106 then searches the online marketplace 112 to locate items matching the search terms 130. The machine learning model 126 initiates a search of the online marketplace 112, such as a search to locate a listing 120 with tags, descriptions, characteristics, or features, matching the search terms 130. The machine learning model 126 may provide the search terms 130 to different types of search interfaces of the online marketplace 112. In at least one implementation, for example, the machine learning model 126 may generate text search queries (e.g., using one or more NLP techniques) and provide the text search queries as input to a search interface that is or includes an interactive element such as a search bar. Alternatively or in addition, the search interface corresponds to an application programming interface (API), such that at least one of the machine learning model 126 or the visual search query system 106 configures the search queries in accordance with the API and provides the search queries as input to the online marketplace 112′s API. The machine learning model 126 may initiate a search of the online marketplace 112 to locate the listing 120 in a variety of ways without departing from the spirit or scope of the described techniques.

The visual search query system 106 displays visual indications 134 of the located items 132 matching the search terms 130 in a user interface of the application 110. Responsive to the search initiated by the machine learning model 126, the visual search query system 106 receives search results that include or otherwise indicate the at least one listing 120 including the located items 132 on the online marketplace 112. In other words, the search results include listings, from the listing data 118, of the items that are available on the online marketplace 112 at the particular time, e.g., in substantially real-time as the search query 122. The visual indications 134 include item images, item information, item videos, or other information related to the located items 132, extracted by the visual search query system 106 from the listing data 118 or from other sources.

In the example depicted at step ‘D’ of the illustrated environment 100, the visual search query system 106 displays the visual indications 134 of the located items 132 including multiple watches from listings having features corresponding to the search terms 130. For instance, the watches have a gender characteristic of “Unisex,” a color of “Titanium,” a brand of “Honeycrisp,” and a designation of “Luxury.” The characteristics of the watches of the located items 132 match the user's intent for the search query 122, and the visual indications 134 therefore display the located items 132 that are of interest to the user.

Having considered an example of an environment, consider now a discussion of some example details of the techniques for visual search query intent extraction and search refinement in accordance with one or more implementations.

### Visual Search Query Intent Extraction and Search Refinement

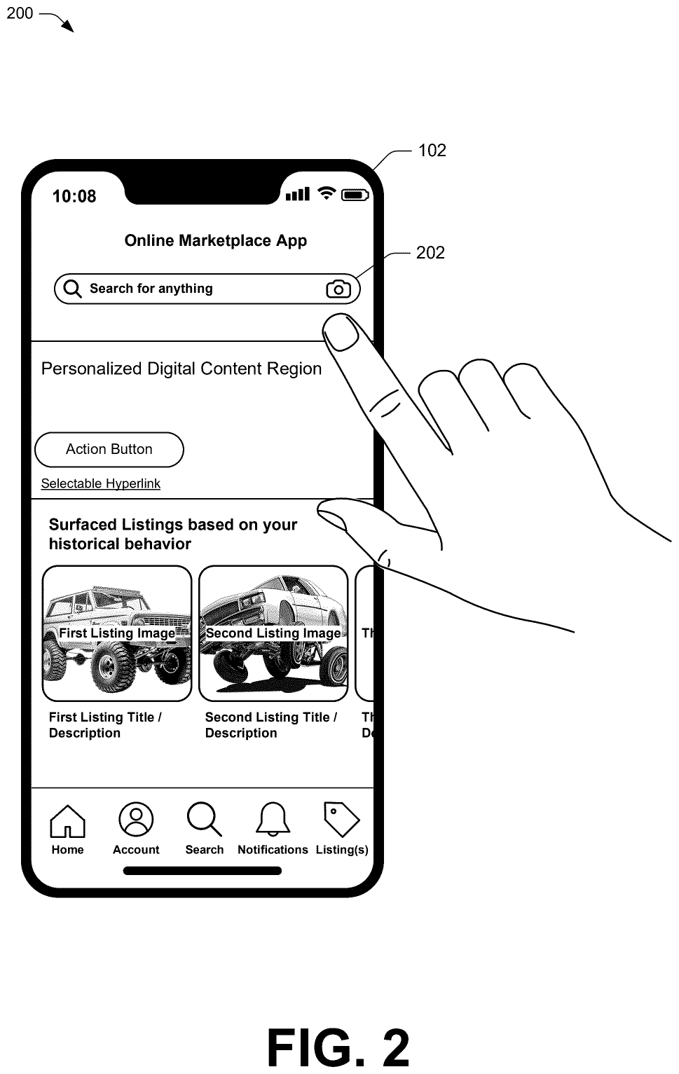

FIG. 2 depicts an example 200 of a user interface for visual search query intent extraction and search refinement. The illustrated example 200 includes the computing device 102 displaying a search user interface 202. The search user interface 202 corresponds to a page generated to receive the search query 122 including the image 124 to locate items listed for sale on the online marketplace 112. In one or more implementations, interactive elements of the search user interface 202 are selectable to initiate the search query 122. As illustrated in this example, the search user interface 202 includes a search bar associated with the online marketplace 112 for initiating the search query 122. The search bar includes a camera button configured to facilitate input of the image 124 as part of the search query 122.

In one or more implementations, user interfaces of the online marketplace 112 and/or that enable visual search query intent extraction and search refinement are different or otherwise vary from the user interfaces discussed herein. Alternatively or additionally, user interfaces used in connection with visual search query intent extraction and search refinement include any combination of the user interface elements discussed herein and/or depicted in FIGS. 2-6 without departing from the spirit or scope of the techniques described herein.

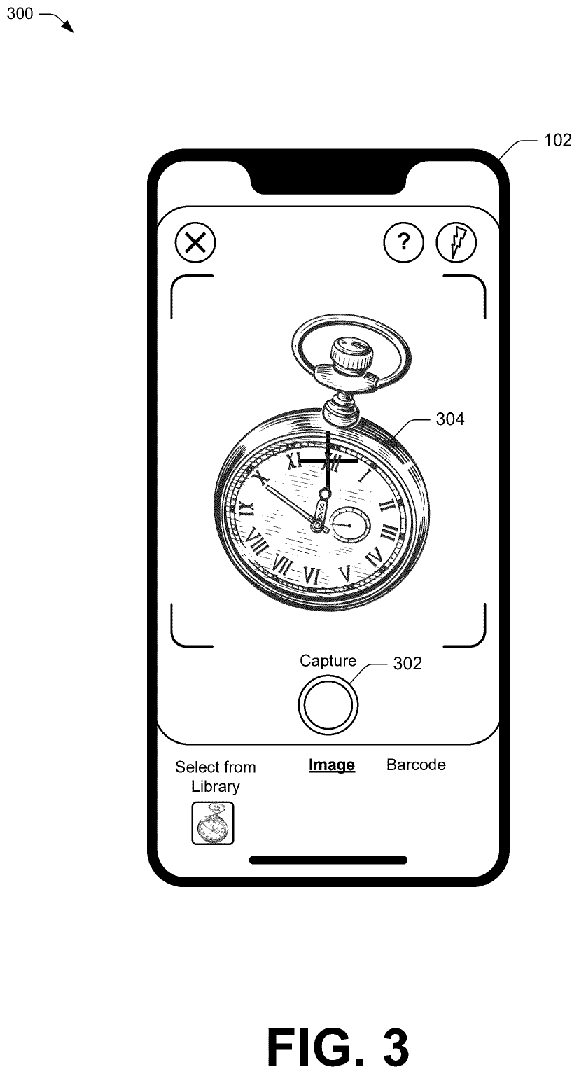

FIG. 3 depicts an example 300 of a user interface for visual search query intent extraction and search refinement including an image capture prompt. Example 300 is a continuation of the example 200 described with respect to FIG. 2.

The illustrated example 300 includes the computing device 102 displaying an image capture prompt 302 in the search user interface 202. The image capture prompt 302 implements a camera feature in the application 110 that allows the user to capture the image 124 using a camera associated with the computing device 102. In response to the image capture prompt 302, the user uses the camera feature of the application 110 to capture the image 124 of an object 304. In this example, the user intends to shop for luxury watches, so the user uses the camera feature of the application 110 to capture an image 124 of a physical pocket watch near the user to initiate a search query 122 for luxury watches with characteristics similar to the pocket watch. The pocket watch is the object 304 in the image 124 and includes at least one feature that the user intends to include in the search query 122 of listings on the online marketplace 112.

Additionally or alternatively, the search user interface 202 includes a link to select the image 124 from a library. In response to the user selecting the link to select the image 124 from the library, the visual search query system 106 connect the user to a camera roll associated with the user on the computing device 102, cloud drive associated with the user, or other library of digital images to enable the user to select the image 124. In other examples, the image 124 is a screenshot of an image of the object 304 or a downloaded image of the object 304 saved to memory of the computing device 102 or other storage device. The visual search query system 106 then receives the search query 122 including the image 124 captured, selected, or uploaded by the user using the search user interface 202.

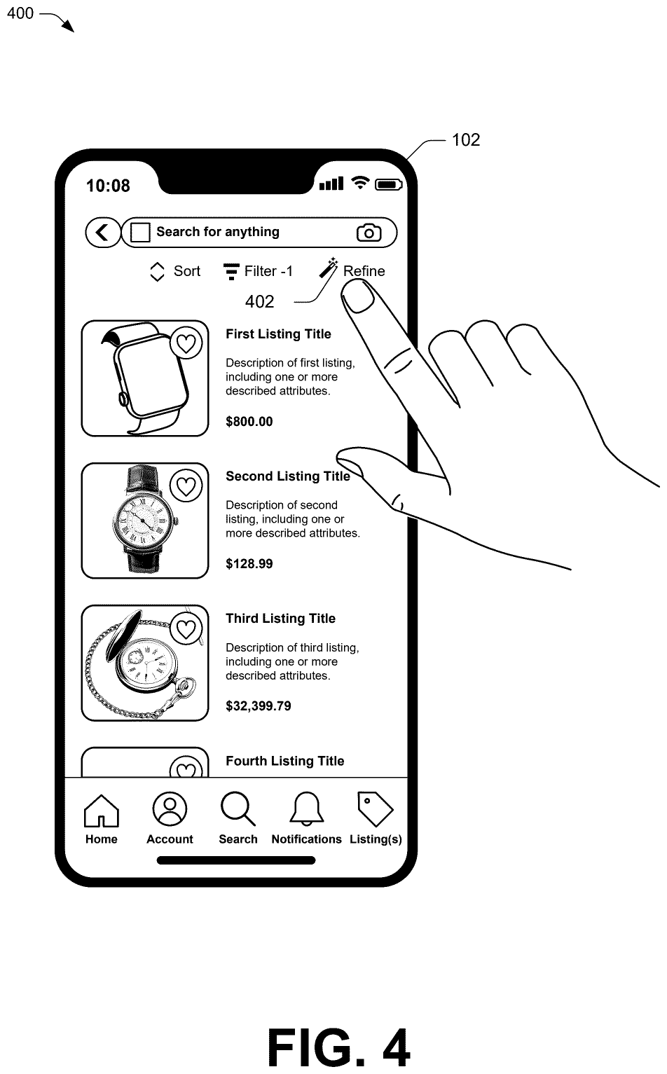

FIG. 4 depicts an example 400 of a user interface for visual search query intent extraction and search refinement including a search refinement prompt. Example 400 is a continuation of the example 300 described with respect to FIG. 3. After the visual search query system 106 receives the search query 122 including the image 124, the visual search query system 106 analyzes the image 124 using a machine learning model 126 to determine characteristics of the object 304 in the image 124.

The illustrated example 400 includes the computing device 102 displaying search refinement prompt 402 in the search user interface 202. To begin, the visual search query system 106 uses the machine learning model 126 to determine characteristics of the object 304 in the image 124. Characteristics of the object 304 include, but are not limited to, item type, gender (e.g., gender of wearer for an object that is a clothing item or accessory), color, brand, price, model, or designation of luxury. The characteristics of the object 304 describe qualities of the object 304 that are of interest to a purchaser.

To identify the characteristics of the object 304 in the image 124, the machine learning model 126 is trained on training data including images of items and corresponding labels describing characteristics of the items from the listing data 118 of the online marketplace 112. During the training process, noise is injected into the images of the items increase accuracy of label prediction of input images that are not professionally photographed images of items. Labels generated by the machine learning model 126 that specify characteristics of the items in the images of the training data are then compared with the corresponding labels describing the characteristics of the items from the listing data 118 to further refine the machine learning model 126. Training of the machine learning model 126 is described in further detail in relation to FIG. 7 below.

After the visual search query system 106 uses the machine learning model 126 to determine characteristics of the object 304 in the image 124, the visual search query system 106 generates search terms 130 based on the characteristics of the object 304 in the image 124. The machine learning model 126 generates and outputs the search terms 130 (e.g., text tags, text strings, or other suitable format of information) to locate items in listings of the online marketplace 112 that include characteristics of the object.

The visual search query system 106 then displays initial search results in the search user interface 202. To do this, the visual search query system 106 searches the online marketplace 112 to locate items matching the search terms 130. The machine learning model 126 initiates a search of the online marketplace 112, such as a search to locate a listing 120 with tags, descriptions, characteristics, or features, matching the search terms 130. The machine learning model 126 may provide the search terms 130 to different types of search interfaces of the online marketplace 112.

In at least one implementation, for example, the machine learning model 126 may generate text search queries (e.g., using one or more NLP techniques) and provide the text search queries as input to a search interface that is or includes an interactive element such as a search bar. Alternatively or in addition, the search interface corresponds to an application programming interface (API), such that at least one of the machine learning model 126 or the visual search query system 106 configures the search queries in accordance with the API and provides the search queries as input to the online marketplace 112's API. The machine learning model 126 may initiate a search of the online marketplace 112 to locate the listing 120 in a variety of ways without departing from the spirit or scope of the described techniques.

The initial search results include various items sharing characteristics of the object 304 in the image 124. However, because the user intended to search for listing on the online marketplace 112 for items sharing some, but not all, characteristics with the object 304, the initial search results may not include items matching the intent of the user. To extract visual search query intent using the image 124 and/or the initial search results, the visual search query system 106 provides a “Refine” option relative to the initial search results. Although this example contemplates displaying initial search results with an option to refine the initial search results, other examples include displaying the search terms 130 with an option to refine the search terms 130.

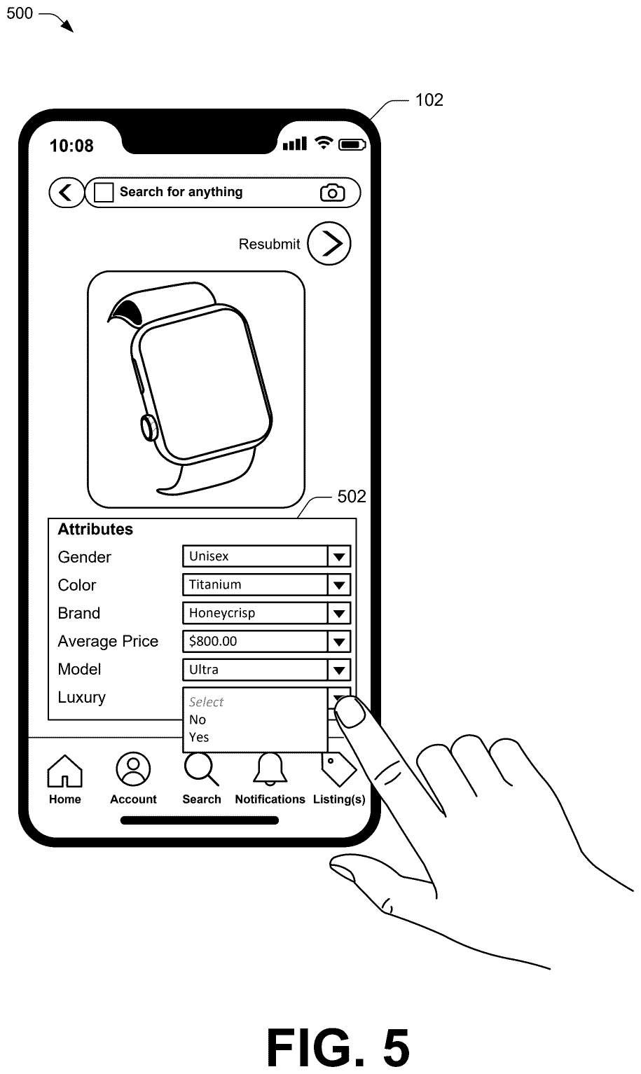

FIG. 5 depicts an example 500 of a user interface for visual search query intent extraction and search refinement including displaying search terms. Example 500 is a continuation of the example 400 described with respect to FIG. 4. After the user selects the option to refine the initial search results or the search terms 130, the visual search query system 106 provides a search term refinement prompt 502 in the search user interface 202.

The illustrated example 500 includes the computing device 102 displaying search terms 130 in the search user interface 202. The search terms 130 are generated by the machine learning model 126 based on characteristics of the object 304 in the image 124 include a gender of “Unisex,” a color of “Titanium,” a brand of “Honeycrisp,” an average price of “$800.00,” a model of “Ultra,” and a luxury designation of “No.”

The search term refinement prompt 502 in the search user interface 202 includes an option for the user to alter, remove, or add the search terms 130. The search term refinement prompt 502 includes checkboxes, drop-down menus, or other options to refine the search terms 130. In this example, the user updates the search terms 130 corresponding to the luxury designation from “No” to “Yes” using a drop-down menu because the user intends to view item listings corresponding to luxury watches. In some examples, changing a luxury designation automatically adjusts the average price search term. Additionally or alternatively, the search term refinement prompt 502 allows the user to broaden or narrow the search query 122 by adjusting the search terms 130. The visual search query system 106 receives the user input to change the search terms 130 and updates the search terms 130 based on the user input, allowing the visual search query system 106 to extract the user's visual search query intent to refine the item search. Providing the search term refinement prompt 502 in the search user interface 202 allows the user to extract visual search query intent and to update the search terms 130 to reflect the intent of the user for the search query 122 for listings on the online marketplace 112.

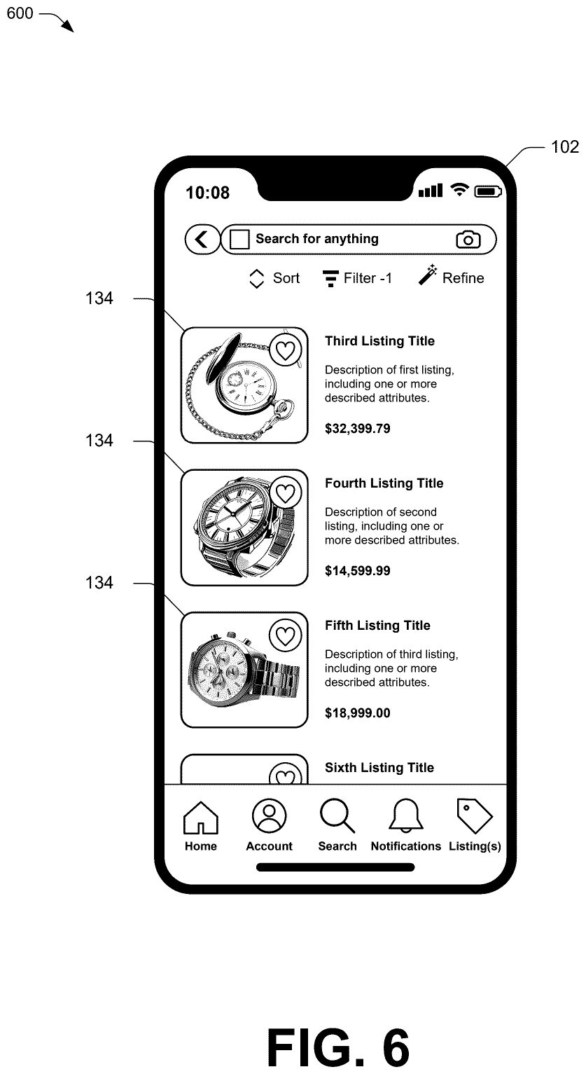

FIG. 6 depicts an example 600 of a user interface for visual search query intent extraction and search refinement including visual indications of located items matching the search terms. Example 600 is a continuation of the example 500 described with respect to FIG. 5. After the visual search query system 106 receives the user input to alter, remove, or add the search terms 130 the visual search query system 106 displays visual indications 134 of located items 132 matching the search terms 130 in the search user interface 202 of the online marketplace 112.

Based on the search terms 130 that are updated, the visual search query system 106 identifies located items 132 by filtering the initial search results or conducting a new search of the online marketplace 112 for a listing 120 matching the search terms 130. To filter the initial search results, the visual search query system 106 excludes listings of the initial search results that do not meet a predetermined threshold level of similarity to the search terms 130.

To conduct a new search of the online marketplace 112 for the listing 120 matching the search terms 130, the visual search query system 106 searches the online marketplace 112 to locate items matching the search terms 130. The machine learning model 126 initiates a search of the online marketplace 112, such as a search to locate a listing 120 with tags, descriptions, characteristics, or features, matching the search terms 130. The machine learning model 126 may provide the search terms 130 to different types of search interfaces of the online marketplace 112.

In at least one implementation, for example, the machine learning model 126 may generate text search queries (e.g., using one or more NLP techniques) and provide the text search queries as input to a search interface that is or includes an interactive element such as a search bar. Alternatively or in addition, the search interface corresponds to an application programming interface (API), such that at least one of the machine learning model 126 or the visual search query system 106 configures the search queries in accordance with the API and provides the search queries as input to the online marketplace 112's API. The machine learning model 126 may initiate a search of the online marketplace 112 to locate the listing 120 in a variety of ways without departing from the spirit or scope of the described techniques.

The visual search query system 106 uses the machine learning model 126 to extract visual information from the listings corresponding to the located items 132. The visual information includes images, videos, graphics, or other information that is descriptive of the located items 132. The visual search query system 106 generates the visual indications 134 based on the visual information.

The illustrated example 600 includes the computing device 102 displaying visual indications 134 in the search user interface 202. The visual indications 134 include an image and a description of each listing of the located items 132. The description includes one or more of the characteristics of the located items 132. For example, the visual indications 134 include images extracted from listings of the located items 132 from the listing data 118 for the online marketplace 112 and descriptions including title and price for the located items 132.

The visual indications 134 correspond to the located items 132 that feature characteristics that the user intends to search for related to an item for purchase. In some examples, the visual search query system 106 uses the machine learning model 126 to rank the visual indications 134 based on relevance to the search query 122 based on the image 124, the search terms 130, or other information. Additionally or alternatively, the visual search query system 106 displays the visual indications 134 proximate to the search terms 130 to allow for further refinement of the search terms 130 using an additional search term refinement prompt. For example, the visual search query system 106 displays the visual indications 134 next to, above, below, layered under, layered over, or in another relation to the search terms 130 in the user interface of the online marketplace 112. In some examples, the visual search query system 106 also displays a link or button relative to the visual indications 134 to purchase a corresponding item of the located items 132. This allows the user to quickly find and purchase a desired item on the online marketplace 112.

FIG. 7 depicts an example 700 of training one or more machine learning models for visual search query intent extraction and search refinement. The machine learning model 126 utilizes algorithms to learn from, and make predictions on, known data by analyzing training data 702 to learn and relearn to generate outputs that reflect patterns and attributes of the training data 702. Examples of machine-learning models include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, and so forth.

The plurality of layers are configurable to include an input layer, an output layer, and one or more hidden layers. Calculations are performed within the layers via hidden states through a system of weighted connections that are “learned” during training of the machine learning model 126. In this example, the machine learning model 126 uses cross-entropy loss to predict multi-label classifications to generate the output label 714. Cross-entropy loss measures performance of the machine learning model 126 including an output that is a probability value between 0 and 1. The cross-entropy loss increases as the probability diverges from an actual label. In some examples, the machine learning model 126 is a multimodal model such as CLIP, which processes and understands information from multiple modalities or sources, such as text, images, audio, and video. Additionally or alternatively, the machine learning model 126 is a vision transformer model, which uses self-attention mechanisms and transformers to divide an image into patches that are then linearly embedded and processed by a transformer architecture.

The machine learning model 126 is trained on training data 702 including a training data pair 704. The training data pair 704 includes a training image 706 and a training label 708 that corresponds to the training image 706. The training image 706 and the training label 708 are collected from the listing data 118 of the online marketplace 112. For example, the training image 706 is an image of an item listed for sale on the online marketplace 112, and the training label 708 is at least one characteristic describing the item from a description of the item in the listing. Additionally or alternatively, the training image 706 is an image captured or used by a buyer on the online marketplace 112 to search for an item during a prior search or transaction.

A noise injection engine 710 injects noise 712 into the training image 706. For example, the noise 712 is Gaussian Noise or other distribution to inject noise, including Poisson Noise. In some examples, injecting the noise 712 includes distorting, rotating, warping, cutting holes, cropping, adding content, removing content, or altering the training image 706 in other ways. Because the training image 706 is a professionally-photographed image in some examples, injecting noise serves to train the machine learning model 126 on images resembling amateurly-photographed images that have more imperfections than professionally-photographed images. In some examples, the training image 706 depicts a known authentic item or a known counterfeit item to train the machine learning model 126 to determine whether an image depicts an authentic item or a counterfeit item.

The machine learning model 126 receives the training image 706 and generates an output label 714 describing the training image 706. The output label 714 includes a characteristic describing an object in the training image 706. To generate the training image 706, the machine learning model 126 object recognition, bounding boxes, saliency maps, or other identification technologies to process the training image 706 and generate the output label 714 describing the training image 706.

Comparison logic 716 of the machine learning model 126 receives the training label 708 corresponding to the training image 706 from the training data 702. Because the training label 708 is a ground truth, or “correct” label, for the training image 706, the comparison logic 716 computes a difference 718 between the output label 714 and the training label 708. In some examples, computing the difference 718 includes calculating a loss function to quantify a loss associated with operations performed by the machine learning model 126 in generating the output label 714. The loss function is configurable in a variety of ways, examples of which include cross-entropy loss, regret, Quadratic loss function as part of a least squares technique, perceptual loss using a pre-trained convolutional neural network, and so forth.

Based on the difference 718, a model adjustment logic 720 of the machine learning model 126 generates an adjustment 722 or multiple adjustments to the machine learning model 126. For example, the model adjustment logic 720 uses a backpropagation operation as part of minimizing the loss function and thereby training parameters of the machine learning model 126. Minimizing the loss function, for instance, includes adjusting weights corresponding to labeling logic to minimize the loss and thereby optimize performance of the machine learning model 126. The adjustment is determined by computing a gradient of the loss function, which indicates a direction to be used in order to adjust the parameters to minimize the loss. The parameters of the machine learning model 126 are then updated based on the computed gradient.

This process of training the machine learning model 126 continues over a plurality of iterations in an example until satisfying one or more stopping criterion. The stopping criterion is employed by the visual search query system 106 in this example to reduce overfitting of the machine learning model 126, reduce computational resource consumption, and promote an ability of the machine learning model 126 to address previously unseen data (e.g., data that is not included specifically as an example in the training data 702). Examples of a stopping criterion include but are not limited to a predefined number of epochs, validation loss stabilization, achievement of a performance improvement threshold, or based on performance metrics such as precision and recall. In this example, the backpropagation operation continues training the machine learning model 126 until the output label 714 converges with the training label 708.

Additionally or alternatively, the machine learning model 126 is trained on buyer behavior data from purchased items. The machine learning model 126 leverages user purchase history to filter the search terms 130 based on characteristics, tags, or previous search terms associated with items that the user has previously purchased. For example, the machine learning model 126 ranks the visual indications 134 based on relevance to predicted user search intent based on the user purchase history. The machine learning model 126 also leverages user search history for items on the online marketplace 112 or other marketplaces that are related to the object 304 in the image 124 of the search query 122.

Having discussed exemplary details of visual search query intent extraction and search refinement, consider now some examples of procedures to illustrate additional aspects of the techniques.

### Example Procedures

This section describes examples of procedures for visual search query intent extraction and search refinement. Aspects of the procedures may be implemented in hardware, firmware, or software, or a combination thereof. The procedures are shown as a set of blocks that specify operations performed by one or more devices and are not necessarily limited to the orders shown for performing the operations by the respective blocks.

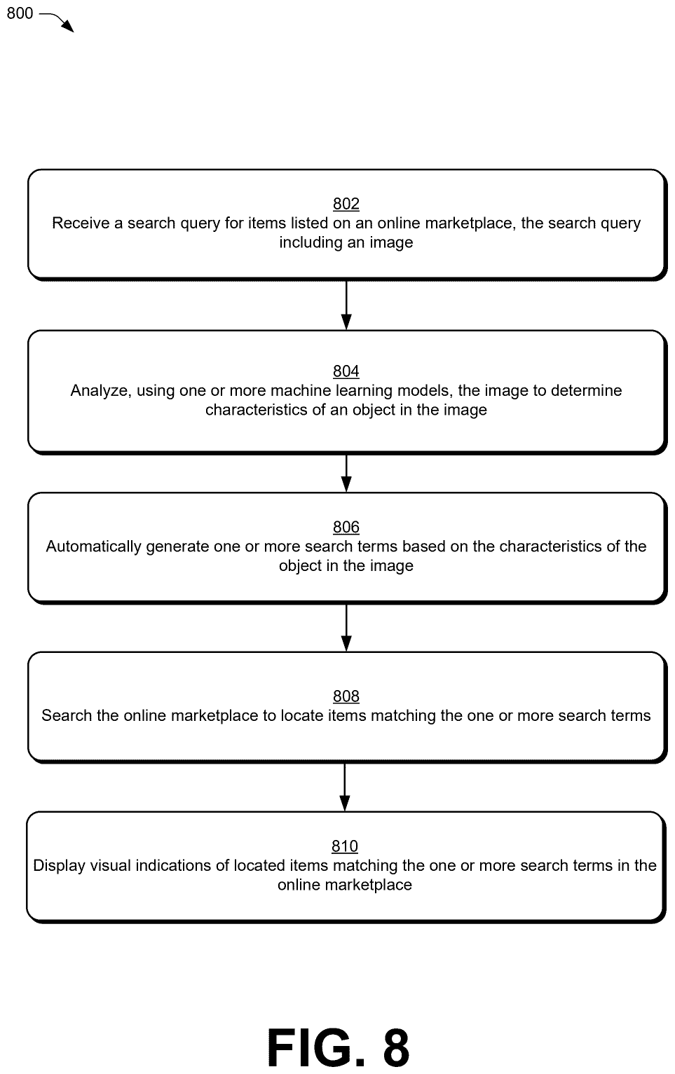

FIG. 8 depicts a procedure 800 in an example implementation of visual search query intent extraction and search refinement. A search query 122 for items listed on an online marketplace 112 is received, the search query 122 including an image 124 (block 802).

The image 124 is analyzed using one or more machine learning models 126 to determine characteristics of an object 304 in the image 124 (block 804). For example, the characteristics are based on intended characteristics of an item to purchase. In at least one implementation, the one or more machine learning models 126 are trained using training data 702 that includes images of items listed on the online marketplace 112, the images of the items associated with characteristics of the items, the characteristics of the items extracted from listing data 118. Some examples further comprise adding noise 712 to the images of the items in the training data 702. In some examples, the one or more machine learning models 126 are trained using training data 702 that includes images uploaded to the online marketplace 112 as part of a search query. Additionally or alternatively, the one or more machine learning models 126 are trained using user purchase history.

One or more search terms 130 are automatically generated based on the characteristics of the object 304 in the image 124 (block 806). For example, the characteristics of the object 304 designate a price, a brand, or a designation of luxury for the object 304 in the image 124.

The online marketplace 112 is searched to locate items matching the one or more search terms (block 808).

Visual indications 134 of the located items 132 matching the one or more search terms 130 are displayed in the online marketplace 112 (block 810). In at least one implementation, the one or more search terms 130 are displayed proximate to the visual indications 134 of the located items 132 in a user interface. Some examples further comprise receiving a user input to remove at least one of the one or more search terms and filtering the visual indications 134 of the located items 132 responsive to the user input to remove the at least one of the one or more search terms 130.

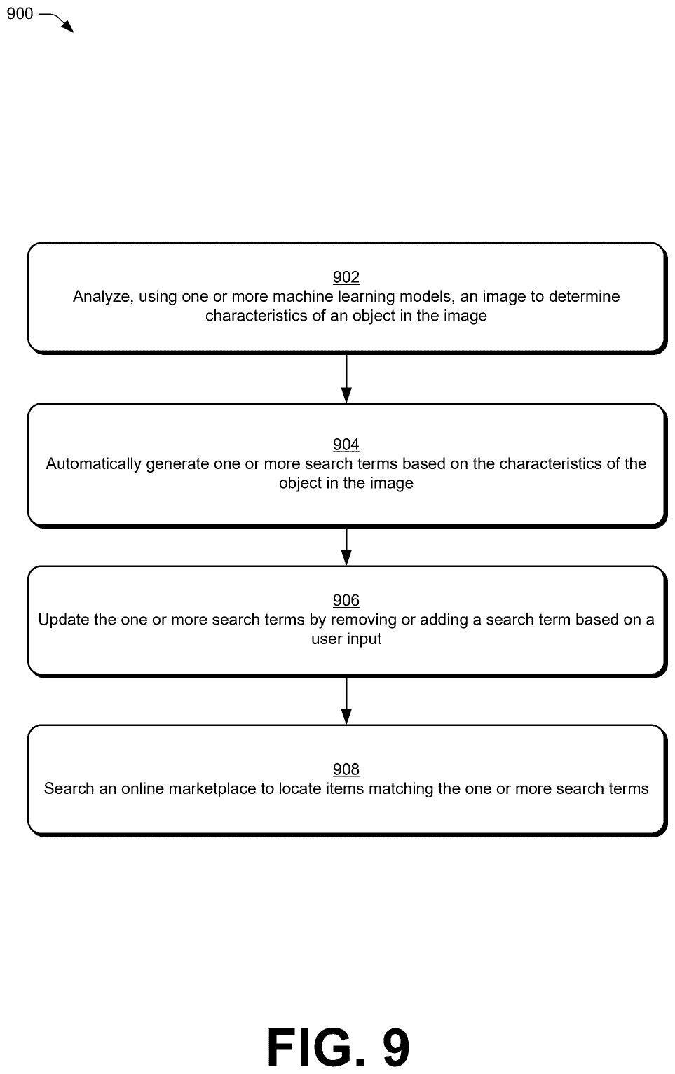

FIG. 9 depicts a procedure 900 in an example implementation of visual search query intent extraction and search refinement. An image 124 is analyzed to determine characteristics of an object 304 in the image 124 using one or more machine learning models 126 (block 902). For example, the one or more machine learning models 126 are trained using training data 702 that includes images of items listed on the online marketplace 112, the images of the items associated with characteristics of the items, the characteristics of the items extracted from listing data 118. Some examples further comprise adding noise 712 to the images of the items in the training data 702. In some examples, the one or more machine learning models 126 are trained using training data 702 that includes images uploaded to the online marketplace 112 as part of a search query. Additionally or alternatively, the one or more machine learning models 126 are trained using user purchase history. For example, the characteristics are based on intended characteristics of an item to purchase.

One or more search terms 130 are automatically generated based on the characteristics of the object 304 in the image 124 (block 904).

The one or more search terms 130 are updated by removing or adding a search term based on a user input (block 906).

An online marketplace 112 is searched to locate items matching the one or more search terms 130 (block 908). In some examples, the one or more search terms 130 are displayed proximate to visual indications 134 of located items 132 matching the one or more search terms 130 in a user interface.

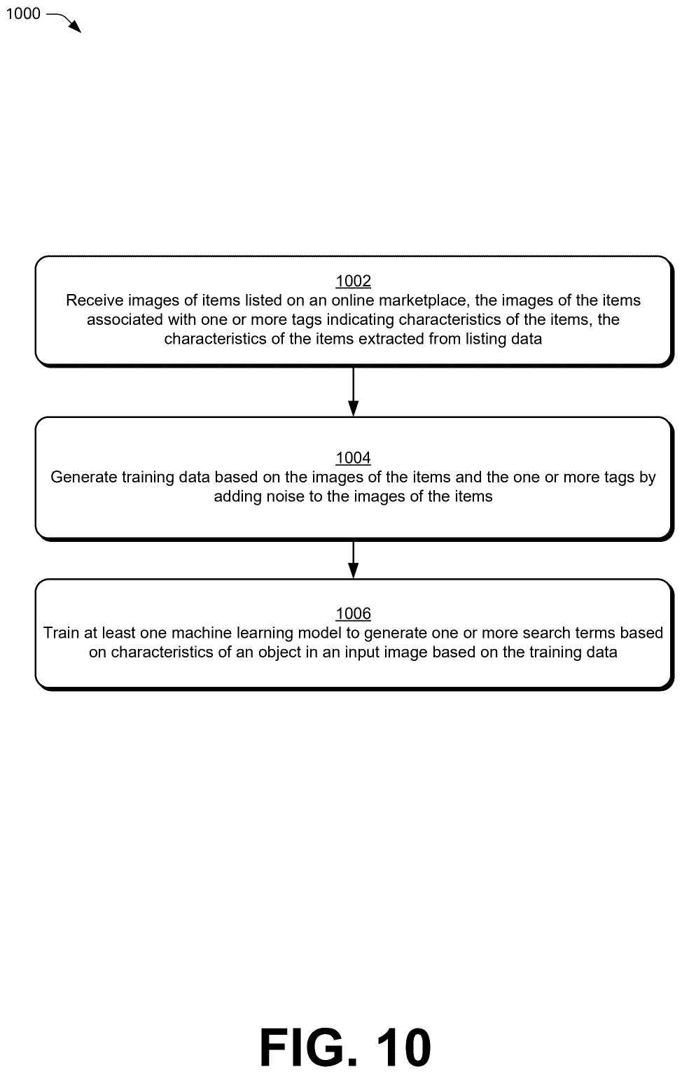

FIG. 10 depicts a procedure 1000 in an example implementation of visual search query intent extraction and search refinement.

Images of items listed on an online marketplace 112 are received, the images of the items associated with one or more tags indicating characteristics of the items, the characteristics of the items extracted from listing data 118 (block 1002).

Training data 702 is generated based on the images of the items and the one or more tags by adding noise 712 to the images of the items (block 1004).

At least one machine learning model 126 is trained to generate one or more search terms 130 based on characteristics of an object 304 in an input image based on the training data 702 (block 1006). In an example, the at least one machine learning model 126 is further trained on images uploaded to the online marketplace 112 as part of a search query. In an additional example, the at least one machine learning model 126 is further trained on user purchase history. Additionally or alternatively, the at least one machine learning model 126 is further trained to update the one or more search terms 130 based on a user input.

Having described examples of procedures in accordance with one or more implementations, consider now an example of a system and device that can be utilized to implement the various techniques described herein.

### Example System and Device

FIG. 11 illustrates an example of a system generally at 1100 that includes an example of a computing device 1102 that is representative of one or more computing systems and/or devices that may implement the various techniques described herein. This is illustrated through inclusion of the application 110 and the visual search query system 106. The computing device 1102 may be, for example, a server of a service provider, a device associated with a client (e.g., a client device), an on-chip system, and/or any other suitable computing device or computing system.

The example computing device 1102 as illustrated includes a processing system 1104, one or more computer-readable media 1106, and one or more I/O interfaces 1108 that are communicatively coupled, one to another. Although not shown, the computing device 1102 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1104 is representative of functionality to perform one or more operations using hardware. Accordingly, the processing system 1104 is illustrated as including hardware elements 1110 that may be configured as processors, functional blocks, and so forth. This may include implementation in hardware as an application specific integrated circuit or other logic device formed using one or more semiconductors. The hardware elements 1110 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 1106 is illustrated as including memory/storage 1112. The memory/storage 1112 represents memory/storage capacity associated with one or more computer-readable media. The memory/storage 1112 may include volatile media (such as random access memory (RAM)) and/or nonvolatile media (such as read only memory (ROM), Flash memory, optical disks, magnetic disks, and so forth). The memory/storage 1112 may include fixed media (e.g., RAM, ROM, a fixed hard drive, and so on) as well as removable media (e.g., Flash memory, a removable hard drive, an optical disc, and so forth). The computer-readable media 1106 may be configured in a variety of other ways as further described below.

Input/output interface(s) 1108 are representative of functionality to allow a user to enter commands and information to computing device 1102, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1102 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 1102. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 1102, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1110 and computer-readable media 1106 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 1110. The computing device 1102 may be configured to implement particular instructions and/or functions corresponding to the software and/or hardware modules. Accordingly, implementation of a module that is executable by the computing device 1102 as software may be achieved at least partially in hardware, e.g., through use of computer-readable storage media and/or hardware elements 1110 of the processing system 1104. The instructions and/or functions may be executable/operable by one or more articles of manufacture (for example, one or more computing devices 1102 and/or processing systems 1104) to implement techniques, modules, and examples described herein.

The techniques described herein may be supported by various configurations of the computing device 1102 and are not limited to the specific examples of the techniques described herein. This functionality may also be implemented all or in part through use of a distributed system, such as over a “cloud” 1114 via a platform 1116 as described below.

The cloud 1114 includes and/or is representative of a platform 1116 for resources 1118. The platform 1116 abstracts underlying functionality of hardware (e.g., servers) and software resources of the cloud 1114. The resources 1118 may include applications and/or data that can be utilized while computer processing is executed on servers that are remote from the computing device 1102. Resources 1118 can also include services provided over the Internet and/or through a subscriber network, such as a cellular or Wi-Fi network.

The platform 1116 may abstract resources and functions to connect the computing device 1102 with other computing devices. The platform 1116 may also serve to abstract scaling of resources to provide a corresponding level of scale to encountered demand for the resources 1118 that are implemented via the platform 1116.

Accordingly, in an interconnected device embodiment, implementation of functionality described herein may be distributed throughout the system 1100. For example, the functionality may be implemented in part on the computing device 1102 as well as via the platform 1116 that abstracts the functionality of the cloud 1114.

### Conclusion

Although the systems and techniques have been described in language specific to structural features and/or methodological acts, it is to be understood that the systems and techniques defined in the appended claims are not necessarily limited to the specific features or acts described. Rather, the specific features and acts are disclosed as example forms of implementing the claimed subject matter.

What is claimed is:

1. A computer-implemented method comprising:
receiving a search query for items listed on an online marketplace, the search query including an image;
analyzing, using one or more machine learning models, the image to determine characteristics of an object in the image;
automatically generating one or more search terms based on the characteristics of the object in the image;
searching the online marketplace to locate items matching the one or more search terms; and
displaying visual indications of located items matching the one or more search terms in the online marketplace.

2. The computer-implemented method of claim 1, further comprising displaying the one or more search terms proximate to the visual indications of the located items in a user interface.

3. The computer-implemented method of claim 1, further comprising:
receiving a user input to remove at least one of the one or more search terms; and
responsive to the user input to remove the at least one of the one or more search terms, filtering the visual indications of the located items.

4. The computer-implemented method of claim 1, wherein the characteristics are based on intended characteristics of an item to purchase.

5. The computer-implemented method of claim 1, wherein the one or more machine learning models are trained using training data that includes images of items listed on the online marketplace, the images of the items associated with characteristics of the items, the characteristics of the items extracted from listing data.

6. The computer-implemented method of claim 5, further comprising adding noise to the images of the items in the training data.

7. The computer-implemented method of claim 1, wherein the one or more machine learning models are trained using training data that includes images uploaded to the online marketplace as part of a search query.

8. The computer-implemented method of claim 1, wherein the one or more machine learning models are trained using user purchase history.

9. The computer-implemented method of claim 1, wherein the characteristics of the object designate a price, a brand, or a designation of luxury for the object in the image.

10. A system comprising:
a memory component; and
a processing device coupled to the memory component, the processing device to perform operations comprising:
analyzing, using one or more machine learning models, an image to determine characteristics of an object in the image;
automatically generating one or more search terms based on the characteristics of the object in the image;
updating the one or more search terms by removing or adding a search term based on a user input; and
searching an online marketplace to locate items matching the one or more search terms.

11. The system of claim 10, further comprising displaying the one or more search terms proximate to visual indications of located items matching the one or more search terms in a user interface.

12. The system of claim 10, wherein the one or more machine learning models are trained using training data that includes images of items listed on the online marketplace, the images of the items associated with characteristics of the items, the characteristics of the items extracted from listing data.

13. The system of claim 12, further comprising adding noise to the images of the items in the training data.

14. The system of claim 10, wherein the one or more machine learning models are trained using training data that includes images uploaded to the online marketplace as part of a search query.

15. The system of claim 10, wherein the one or more machine learning models are trained using user purchase history.

16. The system of claim 10, wherein the characteristics are based on intended characteristics of an item to purchase.

17. A non-transitory computer-readable storage medium storing executable instructions, which when executed by a processing device, cause the processing device to perform operations comprising:
receiving images of items listed on an online marketplace, the images of the items associated with one or more tags indicating characteristics of the items, the characteristics of the items extracted from listing data;
generating training data based on the images of the items and the one or more tags by adding noise to the images of the items; and
training at least one machine learning model to generate one or more search terms based on characteristics of an object in an input image based on the training data.

18. The non-transitory computer-readable storage medium of claim 17, wherein the at least one machine learning model is further trained on images uploaded to the online marketplace as part of a search query.

19. The non-transitory computer-readable storage medium of claim 17, wherein the at least one machine learning model is further trained on user purchase history.

20. The non-transitory computer-readable storage medium of claim 17, wherein the at least one machine learning model is further trained to update the one or more search terms based on a user input.
